(19) United States
(12) Patent Application Publication
(10) Pub. No.: US 2005/0116899 A1
(43) Pub. Date: Jun. 2, 2005

(54) Plasma display panel driving method

(76) Inventors: Su-Yong Chae, Suwon-si (KR); Jeong-Nam Kim, Suwon-si (KR)

Correspondence Address: CHRISTIE, PARKER & HALE, LLP, PO BOX 7068, PASADENA, CA, 91109-7068, US

(21) Appl. No.: 10/998,694

(22) Filed: Nov. 29, 2004

(30) Foreign Application Priority Data
Nov. 29, 2003 (KR) 10-2003-0086091

(51) Int. Cl. G09G 3/20; G09G 3/28

(52) U.S. Cl. 345/60

(57) ABSTRACT

A method for driving a plasma display panel (PDP) and for improving contrast. The PDP includes a middle electrode formed between an X electrode and a Y electrode. A sustain discharge pulse voltage is periodically applied to the X electrode and the Y electrode in a pulse train fashion. In addition, a reset waveform, a scan pulse voltage, and a sustain discharge voltage are applied to the middle electrode. Also, to reduce a discharge amount, a voltage of Vxe or Vye is applied to one of the X and Y electrodes during a fallen waveform period of a reset period.

### CROSS REFERENCE TO RELATED APPLICATION

This application claims priority to and the benefit of Korea Patent Application No. 10-2003-0086091 filed on Nov. 29, 2003 in the Korean Intellectual Property Office, the entire content of which is incorporated herein by reference.

### BACKGROUND OF THE INVENTION

(a) Field of the Invention

The present invention relates to a plasma display panel (PDP) driving method.

(b) Description of the Related Art

Recently, liquid crystal displays (LCDs), field emission displays (FEDs), and plasma displays have been actively developed. Among the flat panel devices, the plasma displays have better luminance and light emission efficiency as compared to the other types of flat panel devices, and also have wider view angles. Therefore, the plasma displays have come into the spotlight as substitutes for the conventional cathode ray tubes (CRTs) in large displays of greater than 40 inches.

The plasma display is a flat display that uses plasma generated via a gas discharge process to display characters or images. Depending on its size, the plasma display can include tens to millions of pixels that are provided thereon in a matrix format. According to supplied driving voltage waveforms and discharge cell structures, plasma displays can be categorized into direct current (DC) plasma displays and alternating current (AC) plasma displays.

Since the DC plasma displays have electrodes exposed in the discharge space without insulation, they allow a current to flow in the discharge space while the voltage is supplied, and therefore they are problematic in that they require resistors for current restriction. On the other hand, since the AC plasma displays have electrodes covered by a dielectric layer, capacitances are naturally formed to restrict the current, and the electrodes are protected from ion shocks in the case of discharging. Accordingly, the AC plasma displays have a longer lifespan than the DC plasma displays.

FIG. 1 shows a partial perspective view of an AC PDP, and FIG. 2 shows a cross-sectional view of the PDP shown in FIG. 1.

As shown in FIGS. 1 and 2, X electrode 3 and Y electrode 4, made of transparent conductive matter and disposed over dielectric layer 14 and protection film 15, are provided in parallel and form a pair with each other under first glass substrate 11. Metallic bus electrodes 6 are respectively formed on the surfaces of X and Y electrodes 3 and 4.

A plurality of address electrodes 5 covered with dielectric layer 14′ are installed on second glass substrate 12. Barrier ribs 17 are formed on dielectric layer 14′ between address electrodes 5, and in parallel with address electrodes 5. Phosphors 18 are formed on the surface of dielectric layer 14′ between barrier ribs 17. First and second glass substrates 11, 12 are provided facing each other with discharge space 19 between first and second glass substrates 11, 12 so that Y electrode 4 and the X electrode 3 may respectively cross address electrodes 5. An address electrode of the address electrode 5 and discharge space 19 formed at a crossing part of Y electrode 4 and X electrode 3 form schematically indicated discharge cell 20.

FIG. 3 shows a conventional PDP electrode arrangement diagram. The conventional PDP electrodes have an m×n matrix configuration. Address electrodes A₁ to Aₘ are arranged in a column direction, and Y electrodes Y₁ to Yₙ and X electrodes X₁ to Xₙ are alternately arranged in a row direction. Discharge cell 20 shown in FIG. 3 substantially corresponds to the discharge cell 20 shown in FIG. 1.

FIG. 4 shows a conventional PDP driving waveform diagram. In a conventional PDP, one frame is divided into a plurality of subfields that are combined to express a gray scale. Each subfield according to the conventional PDP method shown in FIG. 4 includes a reset period, an address period, and a sustain period. The reset period erases wall charges formed during a previous sustain discharge, and sets up new wall charges in order to stably perform functions in a next address period. In the addressing period, the cells that are turned on and the cells that are not turned on in a panel are selected, and wall charges are accumulated on the cells that are turned on (i.e., the addressed cells). In the sustain period, discharge for actually displaying pictures on the addressed cells is performed by alternately applying a sustain discharge voltage to the X and Y electrodes.

Operations of the conventional reset period of the conventional PDP driving method will now be described in more detail. As shown in FIG. 4, the reset period includes an erase period (I), a Y ramp rising period (II), and a Y ramp falling period (III).

Erase Period (I)

While the X electrode is biased with a constant potential of Vbias, a falling ramp which slowly falls from a sustain discharge voltage of Vs to a ground potential (or 0V) is applied to the Y electrode, and the wall charges formed in the sustain period are eliminated.

(2) Y Ramp Rising Period (II)

During this period, the address electrode (not shown) and the X electrode are maintained at 0V, and a ramp voltage gradually rising from the voltage of Vs to the voltage of Vset is applied to the Y electrode. While the ramp voltage rises, a weak reset discharge is generated on all the discharge cells from the Y electrode to the address electrode and the X electrode. As a result, the (−) wall charges are accumulated on the Y electrode, and concurrently, the (+) wall charges are accumulated on the address electrode and the X electrode.

(3) Y Ramp Falling Period (III)

In the latter part of the reset period, a ramp voltage that gradually falls from the voltage of Vs to 0V is applied to the Y electrode under the state that the X electrode maintains the constant voltage of Vbias. While the ramp voltage falls, a weak reset discharge is generated again at all the discharge cells.

In the sustain discharge period, the same sustain discharge voltage Vs is alternately applied to the X and Y electrodes to perform a sustain discharge for displaying actual images on the addressed cells. In this instance, it is desirable to apply symmetric waveforms to the X and Y electrodes during the sustain discharge period.

However, a circuit for driving the Y electrode is different from a circuit for driving the X electrode since a waveform applied to the Y electrode (a waveform for resetting and scanning is additionally applied to the Y electrode) is different from a waveform applied to the X electrode in the reset period of the conventional PDP. Accordingly, the driving circuits of the X and Y electrodes are not impedance-matched, the waveform alternately applied to the X and Y electrodes in the sustain discharge period is distorted, and a bad discharge is generated.

Also, a problematic (or weak) discharge may be generated due to insufficient priming particles generated in the discharge cell when the first (or initial) sustain discharge pulse is applied after the address period in the conventional PDP.

### SUMMARY OF THE INVENTION

It is an aspect of the present invention to provide a PDP and a driving method thereof for preventing bad discharges.

It is another aspect of the present invention to provide a PDP driving method for improving the contrast by reducing the amount of reset light generated during the reset period.

In one exemplary embodiment of the present invention, a method for driving a PDP is provided. The PDP includes a first electrode and a second electrode to which a sustain discharge pulse is applied respectively, and a third electrode formed between the first and second electrodes. During a reset period, the method includes: (a) applying a gently falling voltage waveform, which gently falls from a first voltage to a second voltage, to the third electrode; (b) applying a third voltage which is greater than the second voltage to the first electrode while the gently falling voltage waveform is applied; and (c) applying a fourth voltage which is lower than the third voltage to the second electrode while the gently falling voltage waveform is applied.

In one exemplary embodiment of the present invention, a plasma display is provided. The plasma display includes: a first substrate and a second substrate; a first electrode and a second electrode respectively formed on the first substrate; a third electrode formed between the first and second electrodes; an address electrode formed on the second substrate and formed to cross the first, second, and third electrodes; and a driving circuit for supplying driving voltages to the first, second, third, and address electrodes in order to discharge a discharge cell which is formed by the adjacent first, second, third, and address electrodes, wherein the driving circuit (a) applies a gently falling voltage waveform, which gently falls to a second voltage from a first voltage, to the third electrode, (b) biases the first electrode with a third voltage which is greater than the second voltage, and (c) biases the second electrode with a fourth voltage which is lower than the third voltage during a reset period.

In one exemplary embodiment of the present invention, a method for driving a PDP is provided. The PDP includes a first electrode and a second electrode to which a sustain discharge pulse is applied respectively, and a third electrode formed between the first and second electrodes. The method includes: (a) during a reset period of a first subfield, applying a first falling voltage, which is temporally varied to a fourth voltage from a third voltage which is greater than a first voltage, to the third electrode while the first electrode is biased with the first voltage and the second electrode is biased with a second voltage which is greater than the first voltage; and (b) during a reset period of a second subfield, applying a second falling voltage waveform, which is temporally varied to an eighth voltage from a seventh voltage, which is greater than a sixth voltage, to the third electrode while the first electrode is biased with a fifth voltage which is greater than the fourth voltage and the second electrode is biased with the sixth voltage which is lower than the fifth voltage.

### BRIEF DESCRIPTION OF THE DRAWINGS

The accompanying drawings, together with the specification, illustrate exemplary embodiments of the present invention, and, together with the description, serve to explain the principles of the invention:

FIG. 1 shows a conventional perspective view of an AC PDP;

FIG. 2 shows a cross-sectional view of the PDP shown in FIG. 1;

FIG. 3 shows a conventional PDP electrode arrangement diagram;

FIG. 4 shows a conventional PDP driving waveform diagram;

FIG. 5 shows a PDP electrode arrangement diagram according to certain exemplary embodiments of the present invention;

FIGS. 6 and 7 show a perspective view and a cross-sectional view of the PDP according to certain exemplary embodiments of the present invention;

FIG. 8 shows a PDP driving waveform diagram according to a first exemplary embodiment of the present invention;

FIGS. 9A to 9E show wall charge distribution diagrams based on the driving waveform according to the first exemplary embodiment of the present invention;

FIG. 10 shows a PDP driving waveform diagram according to a second exemplary embodiment of the present invention;

FIG. 11 shows a PDP driving waveform diagram according to a third exemplary embodiment of the present invention; and

FIG. 12 shows a PDP driving waveform diagram according to a fourth exemplary embodiment of the present invention.

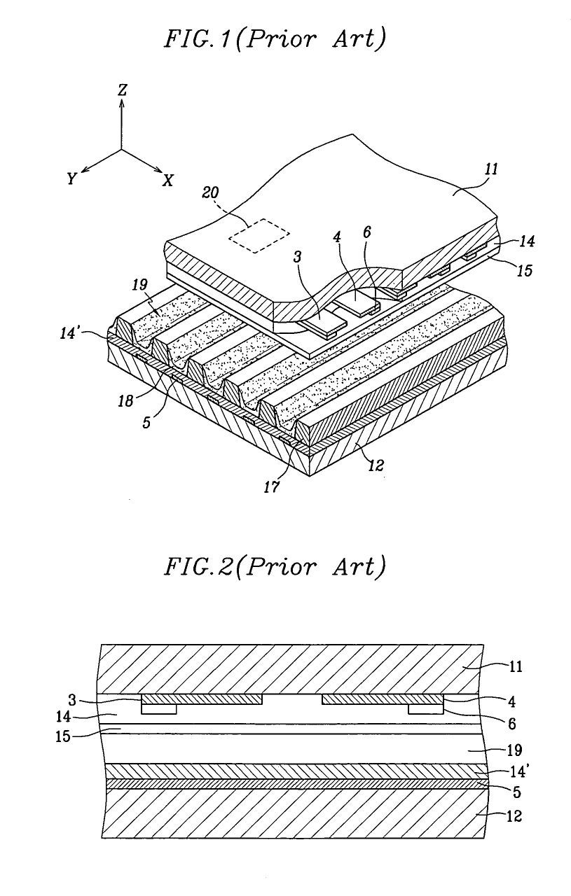

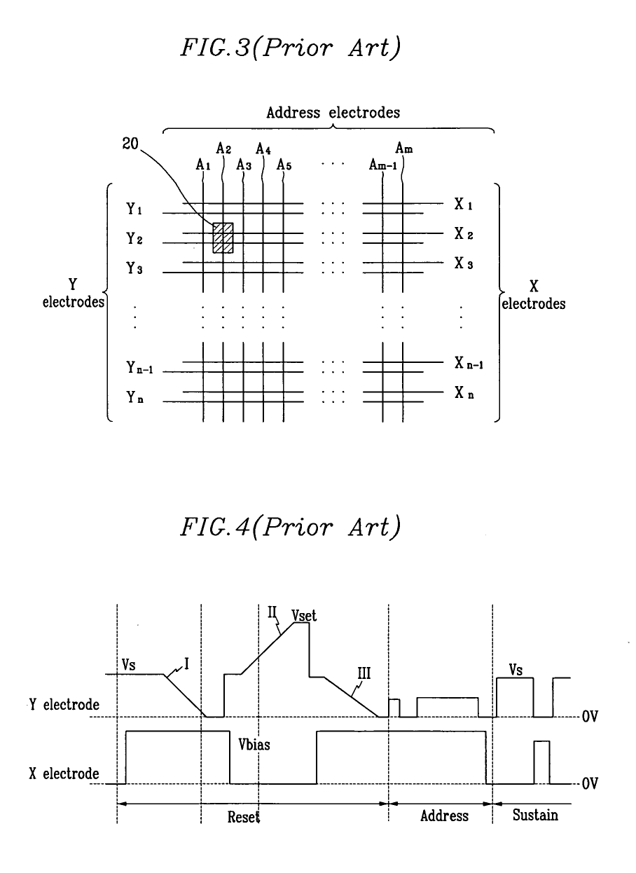

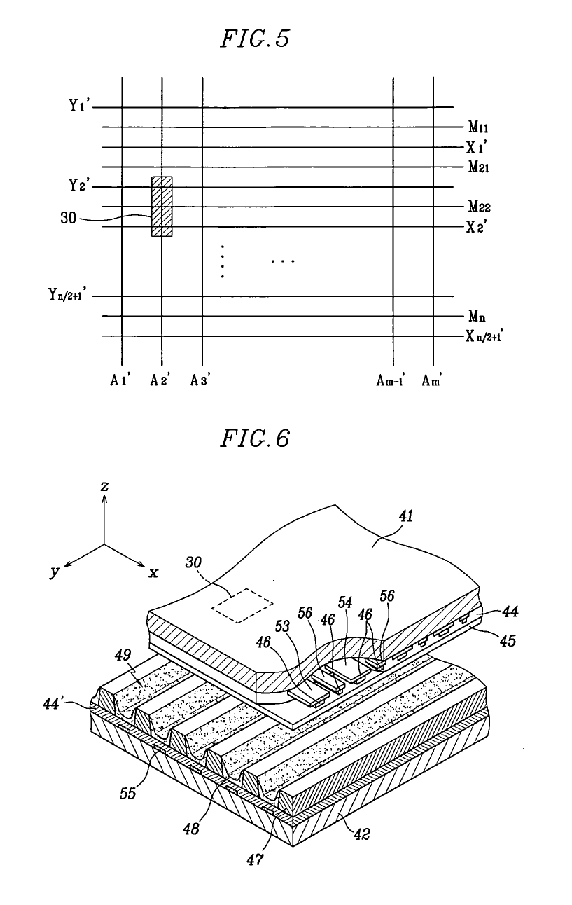

### DETAILED DESCRIPTION

In the following detailed description, only certain exemplary embodiments of the present invention are shown and described, simply by way of illustration. As those skilled in the art would realize, the described exemplary embodiments may be modified in various different ways, all without departing from the spirit or scope of the present invention. Accordingly, the drawings and description are to be regarded as illustrative in nature, and not restrictive.

As shown in FIG. 5, a PDP includes address electrodes A₁′ to Aₘ′ arranged in parallel in a column direction, Y electrodes Y₁′ to Y_{n/2+1}′ in n/2+1 rows, X electrodes X₁′ to X_{n/2+1}′ in n/2+1 rows, and middle electrodes (referred to as M electrodes hereinafter) M₁₁, M₂₁, M₂₂ to Mₙ in n rows. That is, the M electrodes are arranged in the middle of the Y and X electrodes. The Y electrode, the X electrode, the M electrode, and the address electrode has a four-electrode structure to form single discharge cell 30.

The X and Y electrodes function as electrodes for applying sustain discharge voltage waveforms, and the M electrodes function as electrodes for applying a reset waveform and a scan pulse voltage.

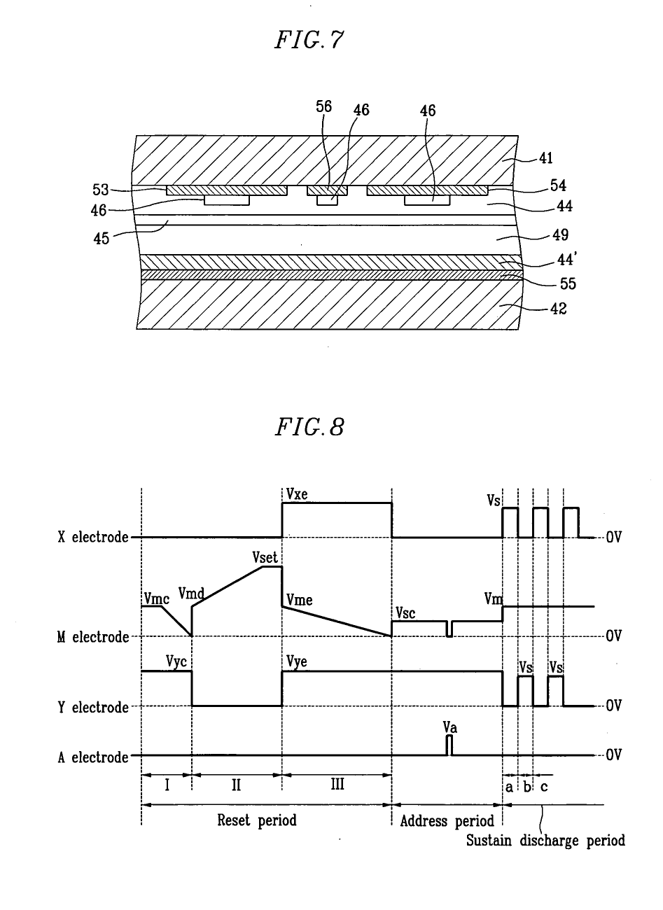

FIGS. 6 and 7 show a perspective view and a cross-sectional view of a PDP according to certain exemplary embodiments of the present invention.

Referring to FIGS. 6 and 7, the PDP includes first substrate 41 and second substrate 42. X electrode 53 and Y electrode 54 are formed on (or under) the first substrate 41. Bus electrodes 46 are formed on the X and Y electrodes 53 and 54, and dielectric layer 44 and protection film 45 are sequentially provided on X and Y electrodes 53 and 54.

Address electrode 55 is formed on (or over) the surface of second substrate 42, and dielectric layer 44′ is formed on address electrode 55. Barrier ribs 47 are formed on the dielectric layer 44′ and discharge spaces 49, which are formed between barrier ribs 47. Discharge spaces 49 include schematically indicated cell 30 that substantially correspond to discharge cell 30 shown in FIG. 5. Phosphors 48 are coated on the surface of barrier rib 47 in the cell space of spaces 49 between barrier ribs 47. X and Y electrodes 53 and 54 are formed to cross (or be perpendicular to) address electrode 55.

In addition, one of middle electrodes 56 is formed between the X and Y electrodes 53 and 43 and on (or under) the surface of first substrate 41. As such, a reset waveform and a scan waveform can be mainly applied to the middle electrode. Bus electrodes 46 are formed on middle electrodes 56.

In general, an exemplary PDP driving method to be subsequently described includes a reset period, an address period, and a sustain period. An X electrode driving circuit (not illustrated) for applying a driving voltage to the X electrode in each period, a Y electrode driving circuit (not illustrated) for applying a driving voltage to the Y electrode, an address electrode driving circuit (not illustrated) for applying a driving voltage to the address electrode, and a driving circuit (not illustrated) for applying a driving voltage to the M electrode are coupled to an exemplary PDP, and the driving circuits and the PDP are coupled to each other to thus configure a plasma display.

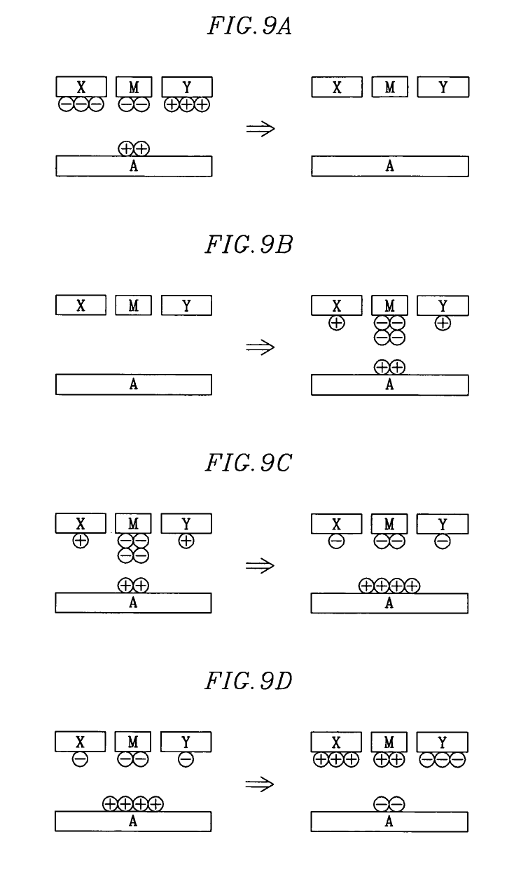

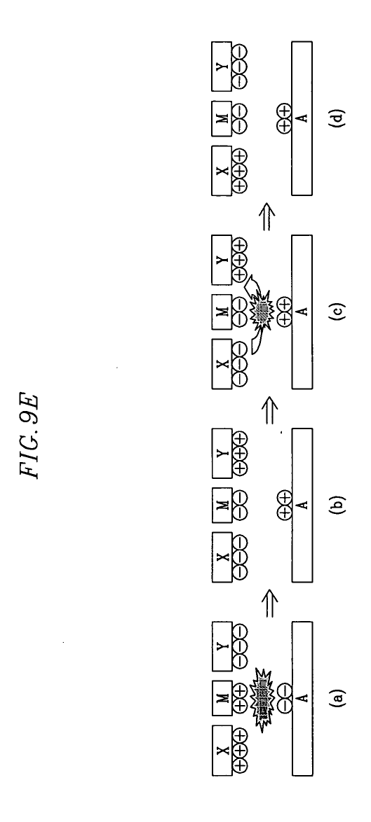

FIG. 8 shows a PDP driving waveform diagram according to a first exemplary embodiment of the present invention, and FIGS. 9A to 9E show distribution diagrams of wall charges based on the driving waveform shown in FIG. 8.

A driving method according to the first exemplary embodiment will now be described with reference to FIGS. 8 and 9A to 9E.

Each subfield includes a reset period, an address period, and a sustain period according to the driving method shown in FIG. 8.

The reset period includes an erase period (I), an M electrode rising waveform period (II), and an M electrode falling waveform period (III).

(1) Reset Period

(1-1) Erase Period (I)

In the erase period, the wall charges formed during a previous sustain discharge period are erased. Assuming that a sustain discharge voltage pulse Vs is applied to the X electrode and a voltage (e.g., a ground voltage) which is lower than the voltage applied to the X electrode is applied to the Y electrode at the last point of the sustain discharge period, (+) wall charges are formed on the Y electrode and the address electrode and (−) wall charges are formed on the X electrode and the M electrode, as shown in FIG. 9A.

In the erase period, a waveform (a ramp waveform or a logarithmic waveform) which gently falls to the ground voltage from the voltage of Vmc is applied to the M electrode while the Y electrode is biased with the voltage of Vyc. Accordingly, the wall charges formed during the sustain discharge period are erased as shown in FIG. 9A.

(1-2) M Electrode Rising Waveform Period (II)

In this period, a waveform (a ramp waveform or a logarithmic waveform) which gently rises to the voltage of Vset from the voltage of Vmd is applied to the M electrode while the X and Y electrodes are biased with the ground voltage. At all the discharge cells, a weak reset discharge is generated from the M electrode to the address electrode, the X electrode, and the Y electrode. As a result, the (−) wall charges are accumulated on the M electrode, and the (+) wall charges are accumulated on the address electrode, the X electrode, and the Y electrode as shown in FIG. 9B.

(1-3) M Electrode Falling Waveform Period (III)

In the latter part of the reset period, a waveform (a ramp waveform or a logarithmic waveform) which gently falls to the ground voltage from the voltage of Vme is applied to the M electrode, while the X and Y electrodes are biased with the voltages of Vxe and Vye respectively. In this instance, the voltage levels should satisfy Vxe=Vye and Vmd=Vme; however, the first exemplary embodiment is not necessarily restricted to this correspondence.

Weak reset discharges are generated at discharge cells again while the ramp voltage falls. In this instance, because the M electrode falling waveform period is a period for slowly reducing the wall charges accumulated during the M electrode rising waveform period, new wall charges can be set up for the next address period (or address discharge) as the time of the falling waveform is increased (i.e., as the gradient becomes gentle) since the reduced amount of wall charges can be precisely controlled.

When the falling waveform is applied to the M electrode, the previous wall charges accumulated on the respective electrode of all the cells are equivalently erased, the new (+) wall charges are stored on the address electrode, and the new (−) wall charges are concurrently stored on the X electrode, the Y electrode, and the M electrode, as shown in FIG. 9C.

(2) Address Period (Scan Period)

In the address period, a scan voltage (e.g., the ground voltage) is sequentially applied to the M electrodes to thus apply a scan pulse, and an address voltage is applied to the address electrodes corresponding to the cells to be discharged (i.e., turned-on cells). In this instance, the X electrode is maintained at the ground voltage, and the voltage of Vye is applied to the Y electrode (i.e., the voltage which is higher than the voltage at the X electrode is applied to the Y electrode.)

A discharge is generated between the M electrode and the address electrode, a discharge is generated between the X electrode and the Y electrode, and as shown in FIG. 9D, the (+) charges are stored at the X and M electrodes and the (−) wall charges are stored at the Y electrode and the address electrode.

(3) Sustain Discharge Period

In the sustain discharge period, a sustain discharge voltage pulse (having voltage Vs) is alternately applied to the X and Y electrodes (in a pulse train fashion) while the M electrode is biased with the sustain discharge voltage of Vm. As such, a sustain discharge is generated at the discharge cells selected in the address period through the application of the sustain discharge voltage and the sustain discharge voltage pulse.

In this instance, discharges are generated through different discharge mechanisms in the initial sustain discharge stage and the normal stage. For ease of description, the discharge which occurs at the initial part of the sustain discharge period will be referred to as a short-gap discharge period, and the discharge at the time away from the initial part (or at normal time) will be referred to as a long-gap discharge period.

(3-1) Short Gap Discharge Period

As shown in parts (a) and (b) of FIG. 9E, (+) voltage pulses are applied to the X electrode and (−) voltage pulses are applied to the Y electrode (wherein the signs of (+) and (−) represent relative concepts caused by comparing the magnitude of the voltage applied to the X with the magnitude of the voltage applied to the Y electrode, and applying the (+) pulse voltages to the X electrode represents applying a voltage which is greater than the voltage applied to the Y electrode to the X electrode and the sign of (−) does not necessarily have to be a negative voltage, i.e., a voltage below 0V) in the start period of the sustain discharge. Concurrently, the (+) voltage pulses are applied to the M electrode. Therefore, the discharges between the X electrode/M electrode and the Y electrode are generated, differing from the conventional discharge generated between the X and Y electrodes. In particular, the electrical field applied between the M and Y electrodes becomes greater since the distance between the M and Y electrodes is shorter than the distance between the X and Y electrodes. Therefore, the discharge between the M and Y electrodes performs a more dominant role than the discharge between the X and Y electrodes. Accordingly, the discharge which occurs at the initial part of the sustain discharge is called the short-gap discharge since the discharge between the M and Y electrodes with a relatively shorter distance performs the leading role in the earlier part of the sustain discharge.

As described, since the relatively higher electric field is applied at the earlier stage of the sustain discharge to generate a short gap discharge, a sufficient discharge is achieved even if insufficient priming particles may be generated in the discharge cell at the time of applying a first (or initial) sustain discharge pulse after the address period.

(3-2) Long Gap Discharge Period

Since the voltage at the M electrode is biased with a constant voltage of Vm after the first sustain discharge pulse of the sustain discharge is applied (e.g., after (a)), the discharge between the M and X electrodes or the discharge between the M and Y electrodes (i.e., the short gap discharge) has less contribution to the discharge, the discharge between the X and Y electrodes becomes the main discharge, and as a result, the input video is displayed according to the number of discharge pulses alternately applied to the X and Y electrodes.

That is, as shown in parts (c) and (d) of FIG. 9E, the (−) wall charges are consecutively stored on the M electrode, and the (−) and (+) wall charges are alternately stored on the X and Y electrodes during the sustain discharge period in the normal state.

According to the first exemplary embodiment, a sufficient discharge is performed when less priming particles are provided since the discharge is performed by the short gap discharge between the X and M electrodes (or between the Y and M electrodes) in the initial part of the sustain discharge (e.g., during the application of the initial or first discharge pulse), and a stable discharge is performed in the normal state since the discharge is performed according to the long gap discharge between the X and Y electrodes.

Also, since almost symmetric voltage waveforms (or pulse periods or pulse widths) are applied to the X and Y electrodes, substantially similar circuits for driving the X and Y electrodes can be used. Therefore, since most of the difference of the circuit impedance between the X and Y electrodes is eliminated, distortion of the pulse waveforms applied to the X and Y electrodes is reduced to allow the stable discharge during the sustain discharge period.

According to the first exemplary embodiment shown in FIG. 8, a PDP of the present invention is driven when the waveforms of the X and Y electrodes are exchanged (or mirrored), and also when the waveforms of the X and Y electrodes are exchanged (or mirrored) in the address period.

As discussed, the reset waveform and the scan pulse waveform are mainly applied to the M electrode, and the sustain voltage waveform is mainly applied to the X and Y electrodes. In exemplary embodiments of the present invention, the reset waveform applied to the M electrode can be the reset waveform shown in FIG. 8, as well as other suitable reset waveforms.

In particular, as is shown in FIG. 8, a suitable waveform which gently falls to the ground voltage from the voltage of Vme is applied to the M electrode while the X and Y electrodes are biased with the voltage of Vxe and Vye in the latter part of the reset period of the driving waveform, that is, in the M electrode falling waveform period (III). In this instance, weak reset discharges are generated between the M electrode with the falling ramp voltage and the X electrode and between the M electrode and the Y electrode. The reset discharges are generated at all the cells, they are not related to presentation of gray scales, but they do precisely control the amount of wall charges for the address discharge. However, since the discharges are concurrently generated between the M electrode and the X electrode and between the M electrode and the Y electrode during the M electrode falling waveform period (III) in the first exemplary embodiment, an amount of emitted light may also increase, and a problem occurs in the shown contrast of the PDP. That is, the reset light increases the brightness of the cells which should emit no light during the sustain period and, thus, lowers the contrast of the PDP.

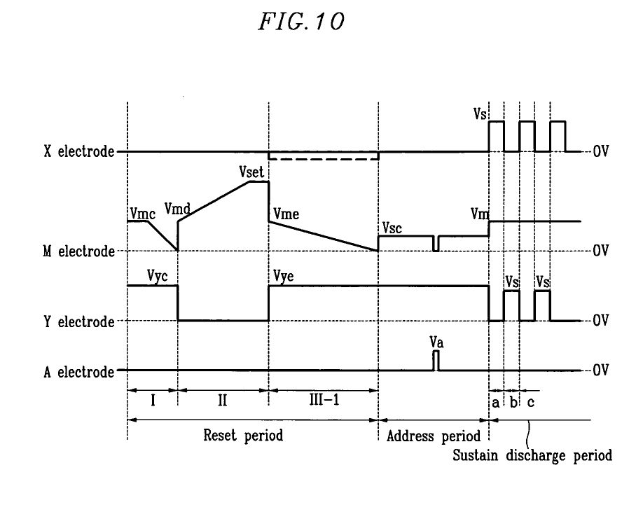

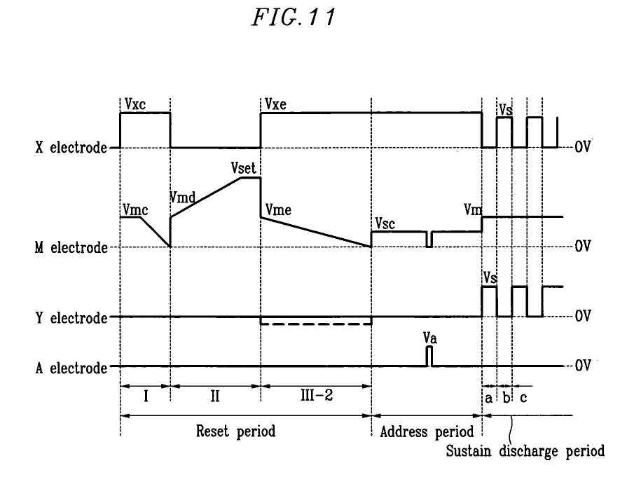

A PDP driving method for reducing the amount of the reset light generated in the M electrode falling waveform period (III) will now be described. FIG. 10 shows a PDP driving waveform diagram according to a second exemplary embodiment of the present invention. In the second exemplary embodiment, a waveform (a ramp waveform or a logarithmic waveform) which gently falls to the ground voltage from the voltage of Vme is applied to the M electrode while the Y electrode is biased with the voltage of Vye in the M electrode falling waveform period (III-1) of the PDP driving method. In this embodiment, the X electrode is biased with the ground voltage. The voltage applied to the X electrode in FIG. 10 is illustrated to be the ground voltage, but alternatively, a negative voltage (as schematically indicated by the dash line shown in FIG. 10) can also be applied thereto. That is, any suitable voltage which is less than the voltage of Vye can be applied to the X electrode for the purpose of reducing the amount of emitted light (the discharged amount) between the M electrode and the Y electrode, and the second exemplary embodiment is not restricted to the ground voltage applied to the X electrode as is shown in FIG. 10.

Since the Y electrode is biased with the voltage of Vye and the M electrode is eventually biased with the ground voltage (or a negative voltage), a weak discharge is generated between the M electrode and the Y electrode and no discharge is generated between the M electrode and the X electrode while the ramp voltage falls. As a result, the amount of emitted light (the discharged amount) in the M electrode falling waveform period (III-1) according to the second exemplary embodiment is reduced to half of that of the first exemplary embodiment.

FIG. 11 shows a PDP driving waveform diagram according to a third exemplary embodiment of the present invention. The waveforms of the X and Y electrodes correspond to that of FIG. 10 except that the waveforms of the X and Y electrodes are exchanged (or mirrored) with the waveforms of FIG. 10. That is, FIG. 11 shows a PDP driving method for reducing the amount of emitted light (the discharged amount) in the reset falling period (III-2) when the final sustain discharge pulse of the sustain period is applied to the X electrode (instead of to the Y electrode as shown in FIG. 10.

Specifically, referring to FIG. 11, a waveform (a ramp waveform or a logarithmic waveform) which gently falls to the ground voltage from the voltage of Vme is applied to the M electrode while the X electrode is biased with the voltage of Vxe in the M electrode falling waveform period (III-2) of the PDP driving method according to the third exemplary embodiment. In this instance, the Y electrode is biased with the ground voltage. The voltage applied to the Y electrode in FIG. 11 is illustrated to be the ground voltage, but alternatively, a negative voltage (as schematically indicated by the dash line shown in FIG. 11) can also be applied thereto. That is, any suitable voltage which is less than the voltage of Vxe can be applied to the Y electrode for the purpose of reducing the amount of emitted light (the discharged amount) between the M electrode and the X electrode, and the third exemplary embodiment is not restricted to the ground voltage applied to the Y electrode in FIG. 11.

Since the X electrode is biased with the voltage of Vxe and the Y electrode is biased with the ground voltage, a weak discharge is generated between the M electrode and the X electrode and no discharge is generated between the M electrode and the Y electrode while the ramp voltage falls. As a result, the amount of emitted light (the discharged amount) in the M electrode falling waveform period (III-2) according to the third exemplary embodiment is reduced to half of that of the first exemplary embodiment.

As can be seen from the above, and according to the second and third exemplary embodiments, the voltage of Vxe or Vye is applied to the one of the X and Y electrodes during the falling waveform period (III-1 or III-2) of the reset period in the PDP driving methods, and hence, the amount of emitted light (the discharged amount) in the falling waveform period is reduced to half of that of the first exemplary embodiment. As a result, the brightness of the discharge cells, which are not sustain-discharged, is reduced by reducing the amount of emitted light generated during the falling waveform period of the reset period, and the contrast is improved.

However, by biasing one of the X and Y electrodes with the voltage of Vxe or Vye in the falling waveform period of the reset period, the second and third exemplary embodiments still have a problem in which the reset discharge is consecutively generated at the M and X electrodes or the M and Y electrodes and an undesired reset light may appear by an accumulation of the consecutively generated discharges. In a fourth exemplary embodiment, the problem of the appeared reset light is solved by alternately applying the driving waveform according to the second and third exemplary embodiments for each frame or each subfield. That is, the problem in which the light caused by the falling reset discharge is solved by alternately generating an M-X falling reset discharge or an M-Y falling reset discharge for each frame or each subfield. This alternate application can be performed periodically or intermittently for each subfield or each frame (e.g., eight subfields) as needed.

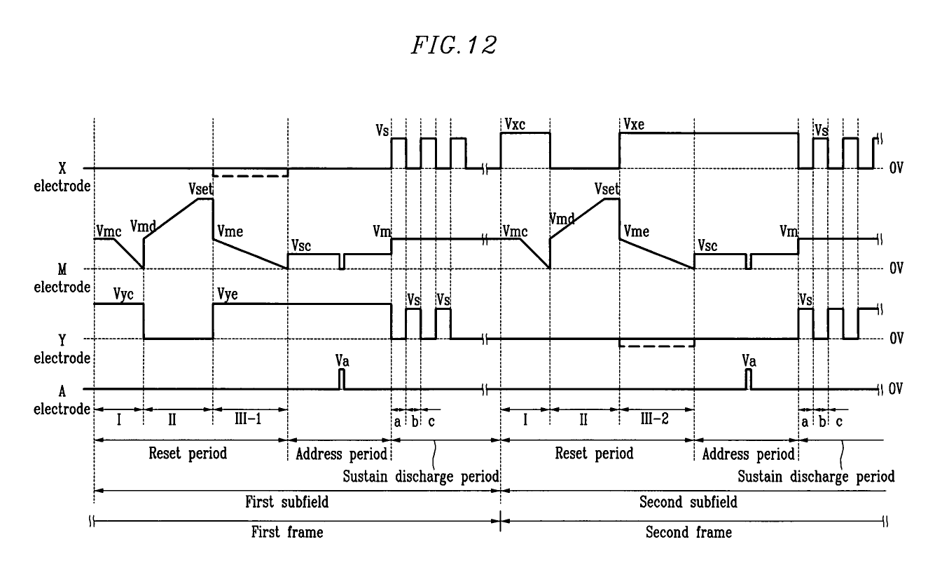

FIG. 12 shows a PDP driving waveform diagram according to the fourth exemplary embodiment of the present invention. In detail, FIG. 12 shows the case in which the M-Y falling reset discharge or the M-X falling reset discharge is realized to be alternately generated for each subfield. As shown, an appropriate voltage is biased with the X or Y electrode so that the reset discharge may be generated between the M and Y electrodes in the reset falling period in the first subfield as shown in FIG. 10, and the reset discharge may be generated between the M and X electrodes in the reset falling period in the second subfield as shown in FIG. 11. The driving waveform shown in FIG. 12 is obtained by combining the waveforms of FIGS. 10 and 11. Also, the waveform shown in FIG. 12 can be alternately applied for each subfield, and it is possible to alternately (rather than consecutively) generate the falling reset discharge between the M and X electrodes or between the M and Y electrodes for each frame. Accordingly, the problem in which the light caused by the accumulation of the consecutively generated discharges is solved by alternately generating an M-X falling reset discharge or an M-Y falling reset discharge for each frame or each subfield. In addition, although FIG. 12 shows that the first subfield is part of a first frame and the second subfield is part of a second frame, it should be recognized by those skilled in the art that the first subfield and the second subfield can be part of a single frame and frames that are not consecutively linked and the invention is not thereby limited. For example, a first frame may include fields having the waveforms of FIG. 10 and a second frame may include fields having the waveforms of FIG. 11 or a single frame may include fields having the waveforms of FIG. 10 and the waveforms of FIG. 11.

In view of the foregoing, bad discharges are prevented by forming a middle electrode between X and Y electrodes, applying the reset waveform and the scan waveform to the middle electrode, and applying the sustain discharge voltage waveform to the X and Y electrodes.

Further, the amount of emitted light during the falling waveform period is reduced to half by applying the voltage of Vxe or Vye to one of the X and Y electrodes during the falling waveform period of the reset period. Through this, the brightness of the discharge cells which are not sustain-discharged is reduced to improve the contrast.

While this invention has been described in connection with certain exemplary embodiments, it is to be understood that the invention is not limited to the disclosed embodiments, but, on the contrary, is intended to cover various modifications included within the spirit and scope of the appended claims.

1. A method for driving a plasma display panel (PDP) including a first electrode and a second electrode to which a sustain discharge pulse is applied respectively, and a third electrode formed between the first and second electrodes,
wherein during a reset period, the method comprises:
(a) applying a gently falling voltage waveform, which gently falls from a first voltage to a second voltage, to the third electrode;
(b) applying a third voltage, which is greater than the second voltage, to the first electrode while the gently falling voltage waveform is applied; and
(c) applying a fourth voltage, which is lower than the third voltage, to the second electrode while the gently falling voltage waveform is applied.

2. The method of claim 1, wherein the fourth voltage is a ground voltage.

3. The method of claim 1, wherein the fourth voltage comprises a negative voltage level.

4. The method of claim 1, wherein a first sustain discharge voltage pulse is applied to the second electrode during a sustain discharge period.

5. The method of claim 1, wherein the first electrode is biased with the third voltage during an address period.

6. The method of claim 1, wherein the first electrode is biased with a voltage which is greater than the fourth voltage during an address period.

7. The method of claim 1, wherein the method occurs during a later period of the reset period.

8. A plasma display comprising:
a first substrate and a second substrate;
a first electrode and a second electrode respectively formed on the first substrate;
a third electrode formed between the first and second electrodes;
an address electrode formed on the second substrate and formed to cross the first, second, and third electrodes; and
a driving circuit for supplying driving voltages to the first, second, third, and address electrodes in order to discharge a discharge cell which is formed by the adjacent first, second, third, and address electrodes,
wherein the driving circuit (a) applies a gently falling voltage waveform, which gently falls to a second voltage from a first voltage, to the third electrode, (b) biases the first electrode with a third voltage which is greater than the second voltage, and (c) biases the second electrode with a fourth voltage which is lower than the third voltage during a reset period.

9. The plasma display of claim 8, wherein the fourth voltage is a ground voltage.

10. The plasma display of claim 8, wherein the fourth voltage comprises a negative voltage level.

11. The plasma display of claim 8, wherein a first sustain discharge voltage pulse is applied to the second electrode during a sustain discharge period.

12. The plasma display of claim 8, wherein the address electrode is formed to be perpendicular to the first, second, and third electrodes.

13. A method for driving a plasma display panel (PDP) including a first electrode and a second electrode to which a sustain discharge pulse is applied respectively, and a third electrode formed between the first and second electrodes,
wherein the method comprises:
(a) during a reset period of a first subfield, applying a first falling voltage waveform, which is temporally varied to a fourth voltage from a third voltage, which is greater than a first voltage, to the third electrode while the first electrode is biased with the first voltage and the second electrode is biased with a second voltage which is greater than the first voltage; and
(b) during a reset period of a second subfield, applying a second falling voltage waveform, which is temporally varied to an eighth voltage from a seventh voltage, which is greater than a sixth voltage, to the third electrode while the first electrode is biased with a fifth voltage which is greater than the fourth voltage and the second electrode is biased with the sixth voltage which is lower than the fifth voltage.

14. The method of claim 13, wherein a first frame includes the first subfield, and a second frame includes the second subfield.

15. The method of claim 14, wherein (a) and (b) are alternately applied for predetermined frames.

16. The method of claim 13, wherein the first and second subfields are included in a frame, and (a) and (b) are alternately applied for each subfield of the frame.

17. The method of claim 13, wherein the first voltage and the sixth voltage substantially have the same voltage level, and the second voltage and the fifth voltage substantially have the same voltage level.

18. The method of claim 13, wherein (a) and (b) are performed periodically.

19. The method of claim 13, wherein (a) and (b) are performed intermittently.
